(19) United States
(12) Patent Application Publication
(10) Pub. No.: US 2026/0362062 A1
(43) Pub. Date: Nov. 12, 2026

(54) MEMS Microphone And Manufacturing Method For Same

(71) Applicant: AAC ACOUSTIC TECHNOLOGIES (SHENZHEN) CO., LTD., Shenzhen (CN)

(72) Inventors: Yuwei Liu, Singapore (SG); Rui Zhang, Shenzhen (CN)

(21) Appl. No.: 19/305,745

(22) Filed: Aug. 20, 2025

Related U.S. Application Data
(63) Continuation of application No. PCT/CN2025/092991, filed on May 7, 2025.

(51) Int. Cl. H04R 19/04; H04R 7/10; H04R 19/00; H04R 31/00

(52) U.S. Cl. CPC H04R 19/04; H04R 7/10; H04R 19/005; H04R 31/003

(57) ABSTRACT

The present invention provides a MEMS microphone and a manufacturing method for the MEMS microphone. The MEMS microphone includes a substrate, a diaphragm, and a backplate. The diaphragm includes a fixing portion and a vibrating portion. The vibrating portion includes a planar part, several recessing membrane parts, and several connecting parts. The recessing membrane parts include a first silicon nitride layer, a silicon oxide layer, and a second silicon nitride layer sequentially stacked along a vibration direction of diaphragm. The first silicon nitride layer is closer to the substrate than the second silicon nitride layer. The MEMS microphone of the present invention uses composite materials to form a corrugated diaphragm. This diaphragm can generate significant displacement under acoustic pressure, thereby attaining high sensitivity. The corrugated diaphragm made of composite materials can disperse stress, enhance the diaphragm’s strength, thereby enhance the reliability of the MEMS microphone.

### FIELD OF THE PRESENT INVENTIONS

The present invention relates to the field of acoustic-electro conversion, and more particularly, to a MEMS microphone and a manufacturing method for same.

### DESCRIPTION OF RELATED ART

With the development of wireless communication, users have increasingly high requirements for the call quality of mobile phones. As the voice pickup device of mobile phones, the design of the microphone directly affects the call quality of mobile phones.

Currently, the MEMS microphone is widely used in mobile phone applications. In related art, the diaphragm of a MEMS microphone is fully fixed, that is, both part of the upper and lower surfaces of the diaphragm are covered and fixed to form a fixed part, which results in lower sensitivity of the MEMS microphone. For such microphones, a diaphragm with a corrugated structure is generally used to overcome the problem of lower sensitivity. However, the problem with the corrugated diaphragm is that the steps of the corrugations can cause stress concentration, resulting in weaker strength and easier breakage of the diaphragm.

Therefore, it is desired to provide a new MEMS microphone which can overcome the above problems.

### SUMMARY

One of the main objects of the present invention is to provide a new MEMS microphone with high sensitivity and high structural strength.

To achieve the above-mentioned objects, the present invention provides a MEMS microphone including a substrate having a cavity, a diaphragm supported on the substrate, and a backplate spaced apart from the diaphragm. The diaphragm includes a fixing portion fixedly connected to the substrate and a vibrating portion suspended above the cavity. The vibrating portion includes a planar part, a plurality of recessing membrane parts spaced apart from the planar part, and a plurality of connecting parts, and each connecting part connecting the planar part and the corresponding recessing membrane part. The recessing membrane parts include a first silicon nitride layer, a silicon oxide layer, and a second silicon nitride layer sequentially stacked along a vibration direction of the diaphragm. The first silicon nitride layer is closer to the substrate than the second silicon nitride layer.

As an improvement, both the fixing portion and the planar part include the first silicon nitride layer, a polysilicon layer, and the second silicon nitride layer sequentially stacked along the vibration direction of the diaphragm, the first silicon nitride layer closer to the substrate than the second silicon nitride layer.

As an improvement, each connecting part includes the first silicon nitride layer, a polysilicon layer, the silicon oxide layer, and the second silicon nitride layer sequentially stacked along the vibration direction of the diaphragm, the first silicon nitride layer closer to the substrate than the second silicon nitride layer.

As an improvement, a thickness of the connecting part of the diaphragm is greater than the thickness of the fixing portion of the diaphragm, greater than the thickness of the planar part, greater than the thickness of the recessing membrane part.

As an improvement, the thickness of the connecting part of the diaphragm is H1, and the thickness of the planar part of the diaphragm is H2, H1 and H2 satisfied the following condition: 2.6≤H1/H2≤3.2.

As an improvement, a recessing depth of the recessing membrane part is greater than a sum of a thickness of the first silicon nitride layer and the thickness of the polysilicon layer.

As an improvement, a thickness of the silicon oxide layer is greater than or equal to the thickness of the polysilicon layer.

As an improvement, the diaphragm includes a first surface facing the substrate and a second surface opposite to the first surface, the backplate arranged on a side of the diaphragm away from the substrate, the MEMS microphone further including a spacer layer arranged between the diaphragm and the backplate, part of the backplate and part of the spacer layer pressing on the second surface of the diaphragm.

The present invention further provides a manufacturing method for a MEMS microphone, the manufacturing method including the following steps:
providing a substrate layer;
depositing a silicon dioxide layer on the substrate layer, and etching the silicon dioxide layer to form a plurality of gaps;
depositing a first silicon nitride layer on the substrate layer and the silicon dioxide layer, the first silicon nitride layer including a plurality of first recessing parts, and each first recessing part located in the corresponding gap;
depositing a polysilicon layer on the first silicon nitride layer, and removing part of the polysilicon layer located in the first recessing parts;
depositing a silicon oxide layer on the polysilicon layer and the first silicon nitride layer, etching the silicon oxide layer, the rest silicon oxide layer located in the first recessing parts and extending to part of the polysilicon layer connected to the first recessing parts, the silicon oxide layer located in the first recessing parts to form a plurality of second recessing parts;
depositing a second silicon nitride layer on the silicon oxide layer and the polysilicon layer;
forming a spacer layer and a backplate on the substrate layer;
etching the substrate layer in reverse to form a substrate having a cavity, removing the silicon dioxide layer to release and form a diaphragm.

As an improvement, the diaphragm includes a fixing portion fixedly connected to the substrate and a vibrating portion suspended above the cavity, the vibrating portion including a planar part, a plurality of recessing membrane parts spaced apart from the planar part, and a plurality of connecting parts, and each connecting part connecting the planar part and the corresponding recessing membrane part, the recessing membrane parts including a first silicon nitride layer, a silicon oxide layer, and a second silicon nitride layer sequentially stacked along a vibration direction of the diaphragm.

### BRIEF DESCRIPTION OF THE DRAWINGS

Many aspects of the exemplary embodiments can be better understood with reference to the following drawing. The components in the drawing are not necessarily drawn to scale, the emphasis instead being placed upon clearly illustrating the principles of the present invention. Moreover, in the drawings, like reference numerals designate corresponding parts throughout the several views.

FIG. 1 is an illustrative isometric view of part of a MEMS microphone in accordance with one embodiment of the present invention.

FIGS. 2 to 8 are flowcharts of a manufacturing method for the MEMS microphone in FIG. 1.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of the present invention more apparent, the present invention is described in further detail together with the figures and the embodiments. It should be understood the specific embodiments described hereby is only to explain the disclosure, not intended to limit the disclosure.

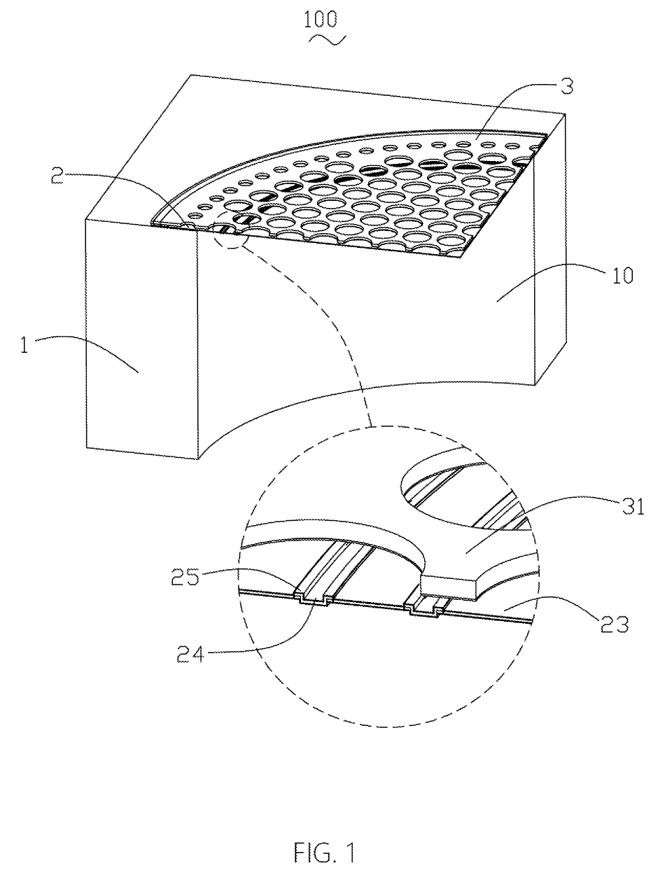

Referring to the FIGS. 1 and 8, the present invention provides a MEMS microphone 100 of the embodiment. FIG. 1 is an illustrative isometric view of part of a MEMS microphone 100 of the present invention. This is only a quarter of the entire MEMS microphone 100, which is composed of four structures as shown in FIG. 1. The MEMS microphone 100 includes a substrate 1 having a cavity 10, a diaphragm 2 supported on the substrate 1, a backplate 3 spaced apart from the diaphragm 2, and a spacer layer 4 arranged between the diaphragm 2 and the backplate 3.

The diaphragm 2 includes a fixing portion 21 fixedly connected to the substrate 1 and a vibrating portion 22 suspended above the cavity 10. The vibrating portion 22 includes a planar part 23, a plurality of recessing membrane parts 24 spaced apart from the planar part 23, and a plurality of connecting parts 25. And each connecting part 25 connects the planar part 23 and the corresponding recessing membrane part 24. The recessing membrane parts 24 include a first silicon nitride layer 261, a silicon oxide layer 262, and a second silicon nitride layer 263 sequentially stacked along a vibration direction of the diaphragm 2. Both the fixing portion 21 and the planar part 23 include the first silicon nitride layer 261, a polysilicon layer 264, and the second silicon nitride layer 263 sequentially stacked along the vibration direction of the diaphragm 2. Each connecting part 25 includes the first silicon nitride layer 261, the polysilicon layer 264, the silicon oxide layer 262, and the second silicon nitride layer 263 sequentially stacked along the vibration direction of the diaphragm 2. The first silicon nitride layer 261 of the recessing membrane part 24 is the same layer as the first silicon nitride layer 261 of the fixing portion 21, the planar part 23, and the connecting parts 25. The second silicon nitride layer 263 of the recessing membrane part 24 is the same layer as the second silicon nitride layer 263 of the fixing portion 21, the planar part 23, and the connecting parts 25. The first silicon nitride layer 261 of the recessing membrane part 24, the fixing portion 21, the planar part 23, and the connecting parts 25 is closer to the substrate 1 than the second silicon nitride layer 263.

A thickness of the connecting part 25 of the diaphragm 2 is the largest in the entire diaphragm 2. That is, the thickness of the connecting part 25 of the diaphragm 2 is greater than the thickness of the fixing portion 21 of the diaphragm 2, greater than the thickness of the planar part 23, greater than the thickness of the recessing membrane part 24. Optionally, the thickness of the connecting part 25 of the diaphragm 2 is H1, and the thickness of the planar part 23 of the diaphragm is H2, H1 and H2 satisfied the following condition: 2.6≤H1/H2≤3.2. A recessing depth of the recessing membrane part 24 is greater than a sum of the thickness of the first silicon nitride layer 261 and the thickness of the polysilicon layer 264. As shown in FIG. 8, the recessing depth of the recessing membrane part 24 is D. The thickness of the silicon oxide layer 262 is greater than or equal to the thickness of the polysilicon layer 264. In present invention, the recessing membrane parts 24, the planar part 23, and the connecting parts 25 cooperate to form a corrugated structure. This corrugated diaphragm can enhance the mechanical sensitivity of the diaphragm.

In this embodiment, the diaphragm 2 is closer to the substrate 1 than the backplate 3, that is, the backplate 3 is arranged on a side of the diaphragm 2 away from the substrate 1. The diaphragm 2 includes a first surface 201 facing the substrate 1 and a second surface 202 opposite to the first surface 201. The first surface 201 is located on the first silicon nitride layer 261, and the second surface 202 is located on the second silicon nitride layer 263. Part of the backplate 3 and part of the spacer layer 4 press on the second surface 202 of the diaphragm 2. In other embodiments, the backplate 3 may also be closer to the substrate 1 than the diaphragm 2.

The backplate 3 includes a backplate support layer 31 and an electrode layer 32 disposed on the side of the backplate support layer 31 closer to the diaphragm 2. The backplate support layer 31 is made of silicon nitride material, and the electrode layer 32 is made of polysilicon material.

The spacer layer 4 is made of silicon oxide material.

Comparing with the related art, the present invention provides a MEMS microphone including a substrate having a cavity, a diaphragm supported on the substrate, and a backplate spaced apart from the diaphragm. The diaphragm includes a fixing portion fixedly connected to the substrate and a vibrating portion suspended above the cavity. The vibrating portion includes a planar part, a plurality of recessing membrane parts spaced apart from the planar part, and a plurality of connecting parts, and each connecting part connecting the planar part and the corresponding recessing membrane part. The recessing membrane parts include a first silicon nitride layer, a silicon oxide layer, and a second silicon nitride layer sequentially stacked along a vibration direction of the diaphragm. The first silicon nitride layer is closer to the substrate than the second silicon nitride layer. The diaphragm of the MEMS microphone of the present invention is made of composite materials, and this diaphragm can generate significant displacement under acoustic pressure, thereby attaining high sensitivity. The corrugated diaphragm made of composite materials can disperse stress, enhance the diaphragm’s strength, and enhance the reliability of the MEMS microphone.

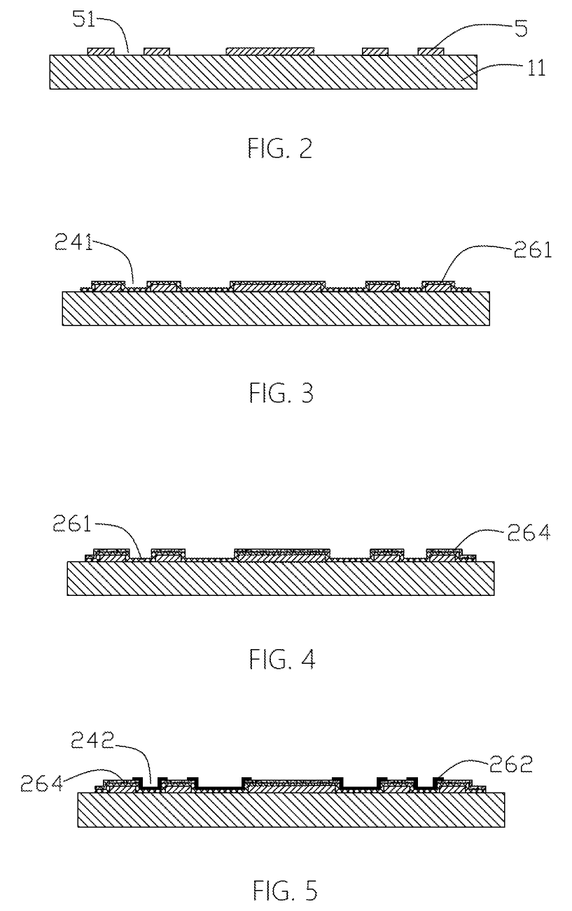

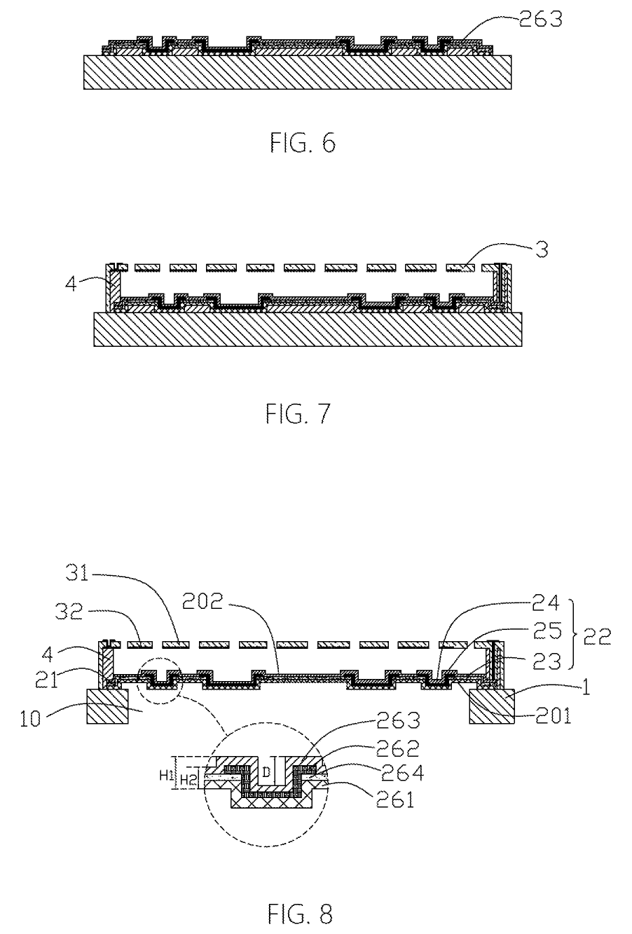

Referring to the FIG. 2 to FIG. 8, the present invention further provides a manufacturing method for a MEMS microphone 100. The manufacturing method includes the following steps:

Providing substrate material to form a substrate layer 11.

Depositing a silicon dioxide layer 5 on the substrate layer 11, and etching the silicon dioxide layer 5 to form a plurality of gaps 51.

Depositing a first silicon nitride layer 261 on the substrate layer 11 and the silicon dioxide layer 5. The first silicon nitride layer 261 includes a plurality of first recessing parts 241, and each first recessing part 241 is located in the corresponding gap 51.

Depositing a polysilicon layer 264 on the first silicon nitride layer 261, and removing part of the polysilicon layer 264 located in the first recessing parts 241 to expose part of the first silicon nitride layer 261.

Depositing a silicon oxide layer 262 on the polysilicon layer 264 and the first silicon nitride layer 261. Etching the silicon oxide layer 262, and the rest silicon oxide layer 262 located in the first recessing parts 241 and extending to part of the polysilicon layer 264 connected to the first recessing parts 241. The silicon oxide layer 262 is located in the first recessing parts 241 to form a plurality of second recessing parts 242.

Depositing a second silicon nitride layer 263 on the silicon oxide layer 262 and the polysilicon layer 264.

Forming a spacer layer 4 and a backplate 3 on the substrate layer 11.

Etching the substrate layer 11 in reverse to form a substrate 1 having a cavity 10. Removing the silicon dioxide layer 5 to release and form a diaphragm 2.

So far, the entire MEMS microphone 100 has been fabricated.

Comparing with the related art, the present invention provides a manufacturing method for the MEMS microphone. The diaphragm of the MEMS microphone manufactured by this method is made of composite materials, and this diaphragm can generate significant displacement under acoustic pressure, thereby attaining high sensitivity. The corrugated diaphragm made of composite materials can disperse stress, enhance the diaphragm’s strength, and enhance the reliability of the MEMS microphone.

It is to be understood, however, that even though numerous characteristics and advantages of the present exemplary embodiments have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A MEMS microphone, comprising:
a substrate having a cavity;
a diaphragm supported on the substrate, the diaphragm comprising a fixing portion fixedly connected to the substrate and a vibrating portion suspended above the cavity, the vibrating portion comprising:
a planar part;
a plurality of recessing membrane parts spaced apart from the planar part, the recessing membrane parts comprising a first silicon nitride layer, a silicon oxide layer, and a second silicon nitride layer sequentially stacked along a vibration direction of the diaphragm, the first silicon nitride layer closer to the substrate than the second silicon nitride layer; and
a plurality of connecting parts, and each connecting part connecting the planar part and the corresponding recessing membrane part; and
a backplate spaced apart from the diaphragm.

2. The MEMS microphone as described in claim 1, wherein both the fixing portion and the planar part comprise the first silicon nitride layer, a polysilicon layer, and the second silicon nitride layer sequentially stacked along the vibration direction of the diaphragm, the first silicon nitride layer closer to the substrate than the second silicon nitride layer.

3. The MEMS microphone as described in claim 1, wherein each connecting part comprises the first silicon nitride layer, a polysilicon layer, the silicon oxide layer, and the second silicon nitride layer sequentially stacked along the vibration direction of the diaphragm, the first silicon nitride layer closer to the substrate than the second silicon nitride layer.

4. The MEMS microphone as described in claim 1, wherein a thickness of the connecting part of the diaphragm is greater than the thickness of the fixing portion of the diaphragm, greater than the thickness of the planar part, greater than the thickness of the recessing membrane part.

5. The MEMS microphone as described in claim 4, wherein the thickness of the connecting part of the diaphragm is H1, and the thickness of the planar part of the diaphragm is H2, H1 and H2 satisfied the following condition: 2.6≤H1/H2≤3.2.

6. The MEMS microphone as described in claim 2, wherein a recessing depth of the recessing membrane part is greater than a sum of a thickness of the first silicon nitride layer and the thickness of the polysilicon layer.

7. The MEMS microphone as described in claim 2, wherein a thickness of the silicon oxide layer is greater than or equal to the thickness of the polysilicon layer.

8. The MEMS microphone as described in claim 1, wherein the diaphragm comprises a first surface facing the substrate and a second surface opposite to the first surface, the backplate arranged on a side of the diaphragm away from the substrate, the MEMS microphone further comprising a spacer layer arranged between the diaphragm and the backplate, part of the backplate and part of the spacer layer pressing on the second surface of the diaphragm.

9. A manufacturing method for a MEMS microphone, the manufacturing method comprising the following steps:
providing a substrate layer;
depositing a silicon dioxide layer on the substrate layer, and etching the silicon dioxide layer to form a plurality of gaps;
depositing a first silicon nitride layer on the substrate layer and the silicon dioxide layer, the first silicon nitride layer comprising a plurality of first recessing parts, and each first recessing part located in the corresponding gap;
depositing a polysilicon layer on the first silicon nitride layer, and removing part of the polysilicon layer located in the first recessing parts;
depositing a silicon oxide layer on the polysilicon layer and the first silicon nitride layer, etching the silicon oxide layer, the rest silicon oxide layer located in the first recessing parts and extending to part of the polysilicon layer connected to the first recessing parts, the silicon oxide layer located in the first recessing parts to form a plurality of second recessing parts;
depositing a second silicon nitride layer on the silicon oxide layer and the polysilicon layer;
forming a spacer layer and a backplate on the substrate layer;
etching the substrate layer in reverse to form a substrate having a cavity, removing the silicon dioxide layer to release and form a diaphragm.

10. The manufacturing method for a MEMS microphone as described in claim 9, wherein the diaphragm comprises a fixing portion fixedly connected to the substrate and a vibrating portion suspended above the cavity, the vibrating portion comprising a planar part, a plurality of recessing membrane parts spaced apart from the planar part, and a plurality of connecting parts, and each connecting part connecting the planar part and the corresponding recessing membrane part, the recessing membrane parts comprising a first silicon nitride layer, a silicon oxide layer, and a second silicon nitride layer sequentially stacked along a vibration direction of the diaphragm.
